(19) United States
(12) Patent Application Publication
(10) Pub. No.: US 2004/0095959 A1
(43) Pub. Date: May 20, 2004

(54) Access network for transmiting data packets between a network and a terminal via a radio communication system, and method for operating the same

(76) Inventors: Bruno Fiter, Lannion (FR); Hans-Ulrich Flender, Ulm (DE); Notker Gerlich, Haar (DE); Thomas Rein, Balzheim (DE)

Correspondence Address: STAAS & HALSEY LLP, SUITE 700, 1201 NEW YORK AVENUE, N.W., WASHINGTON, DC, 20005, US

(21) Appl. No.: 10/380,796

(22) PCT Filed: Sep. 12, 2001
(86) PCT No.: PCT/DE01/03508

(30) Foreign Application Priority Data
Sep. 19, 2000 (DE) 10046344.4

(51) Int. Cl. H04L 12/66; H04J 3/16

(52) U.S. Cl. 370/466; 370/352

(57) ABSTRACT

The invention relates to an access network for transmitting data packets between a network (NW) and a terminal (UE) via a radio communication system, and to a method for operating the same. The access network (AN) comprises a number of nodes (UPS) that are each linked with at least one radio station of the radio communication network and that are adapted to convert data stemming from the network (NW) to a format that is compatible with the transmission in the radio communication system. A permanent first address is defined for the terminal (UE). Data packets that are directed to the first address are forwarded to the address of a processor (VMH) allocated to the terminal (UE), said processor emulating the terminal (UE) in the access network and tracing its movement. The processor behaves towards the network (NW) as a mobile terminal that is compatible with a mobility protocol (Mobile IP, Cellular IP, IPv6).

The invention relates to an access network for transmitting data packets between a network and a terminal via a radio communication system, and to a method for operating same.

For the networked operation of the data terminals it is necessary for each such data terminal to be assigned an address within the network, which in each case can be included with the data packet being transmitted on the network, in order to enable correct forwarding of the data packets in the network to the intended destination terminal. Internet Protocol 14 Version 4, for example, uses an address for each connected computer that can be represented as a sequence of numbers separated by periods, with the numbers being used in a similar manner to the characters of the postal code system used by Deutsche Post (German Post Office) to describe the location of the computer. A structure of this kind enables a transit node of the network to transmit a data packet to be forwarded onwards in the correct direction, without having to know the complete structure of the network in detail to do so.

A problem with a network of this kind is that it does not support the mobility of individual terminals within the network. If one assumes that a terminal, e.g. with the Internet Protocol Version 4 address a1.b1.c1.d1 (whereby a1, b1, c1, d1 in each case are real numbers less than 255), is to be operated not through its assigned nodes a1.b1.c1 but instead at a different location, via node a1.b2.c2, the terminal can of course possibly insert data packets into the network, which could also reach their destination, but a response of the destination computer to which such a data packet is sent would, however, send it to the destination address a1.b1.c1.d1. Because the terminal is not at this location, the response would be lost and no communication would take place.

In order to remedy this problem at least in part, Internet Protocols have been developed that enable computer systems to access the Internet regardless of location. One agent is the Mobile-IP Protocol (IETF RFC 2002: IP Mobility Support). In the adapted form, this protocol is also a component of the Internet Protocol Version 6 standard. This protocol ensures that a second address, called the care-of address, is assigned to a terminal if it is not connected to a node that is not its home node. This care-of address is communicated to a home agent, as it is called, at the home node of the terminal. The home agent is then able to detect data packets at the home node, that are meant for the terminal, i.e. carry its first address, and forward them, provided with the care-of address, tunneled to the terminal.

This technique enables mobility of the terminals to a limited extent. It is possible to connect a terminal via a line connection or a radio link to an external node that is not its home node, and to send and receive data through this node provided the terminal remains connected to the external node. With this arrangement, the terminal transmits directly to a required destination, by providing data packets with its address, but the data packets addressed to the terminal, on the other hand, are diverted through the home agent.

If the connection is a radio link in a cellular radio communication system, mobility of the terminal is possible even during a continuous transmission session, but only within the radio cell of a station of the radio communication system to which the external node is connected. If the terminal moves to a radio cell of a different station connected to a different external node, the transmission session must be interrupted in order for the terminal to communicate a new care-of address to the other external node. Only when this is present can data packets be again transmitted to the terminal. Genuine roaming is as yet not possible with this technique.

The object of the invention is to provide an access network for transmitting data packets between a network and a terminal via a radio communication system and a method for operation of same, that enables complete mobility of the terminal including during the transition from one external node to another during a continuous transmission session.

This object is achieved by the access network with the features of claim 1 and a method with the features of claim 5.

The basic concept of the invention is that the second address or care-of address used to divert the data packets to a terminal connected to an external node are no longer assigned directly to the terminal, but rather to a processor at the node that moreover provides the format conversion necessary for the radio transmission of the data packets to this terminal. Although a format conversion of this kind does also necessarily take place with conventional access networks, this conventional format conversion is merely a type of “filter” through which the data packets must necessarily pass on their way through the terminal designated by the care-of address, without the possibility of appropriate addressing.

In that in accordance with the invention the part of the node that performs this format conversion is constructed as a separate processor that can be independently addressed and is the address to which the first data control unit diverts the packet addressed on the terminal, the possibility is afforded to temporarily assign two such processors at the nodes corresponding to the two cells to one terminal during the transition from one cell of a radio communication system to another. While the processor is being established at the new cell and being assigned to the terminal, the data meant for the terminal can continue to be addressed to the processor of the old cell and forwarded from this to the terminal; only when the process of establishing a new processor at the new cell has been completed does a diversion of data packets for the terminal to the new processor take place within the access network. This process is fully transparent for the terminal and requires no control by the terminal.

In this way, a cost-effective standard access network is created that enables mobile operation of terminals without the need to adapt the terminals themselves to the mobility for this purpose. The access network can offer users of existing terminals a genuine additional utilization feature in this way, without the user of the terminals having to make an own investment for this purpose.

### Advantageous Embodiments are the Object of Subclaims.

In principle, the processors can be designed as distinguishable circuit elements at the nodes. Preferably in any case they are virtual, i.e. they are defined only by a share of the processing resources such as computing power and storage capacity of the nodes and exist at addressable units only for as long as a terminal is assigned to them.

To avoid loss of data when a terminal changes from a radio station of a radio station communication network connected to a first node to a radio station connected to a second node, a second data control unit is preferably provided at each processor, which serves to detect data packets meant for the terminal that arrive at the processor after communication between the relevant processor and the terminal has broken off and forward these to the address of the new processor assigned to the terminal.

After a new processor with a new address has been assigned to the terminal on the change to a new radio station, this is suitably also transmitted to the first data control unit, so that data packets fed into the access network and meant for the terminal can be passed directly to the new processor without a diversion via the second data control unit of the old processor.

The address assigned to the processor is suitably formed in each case by means of a prefix specific to the access network and a designator specific to the terminal, with the specificity meaning that the prefix or designator enables unambiguous identification of the access network or terminal under all the networks or terminals in question. An address formed in this way can be allocated “blind” at any time, i.e. without checking whether it has already been allocated, because by their nature they can only be unambiguous. The International Mobile Subscriber Identity (IMSI) of the terminal is particularly suitable as a designator.

### An example of an embodiment is explained in more detail in the following with the aid of drawings. These are as follows:

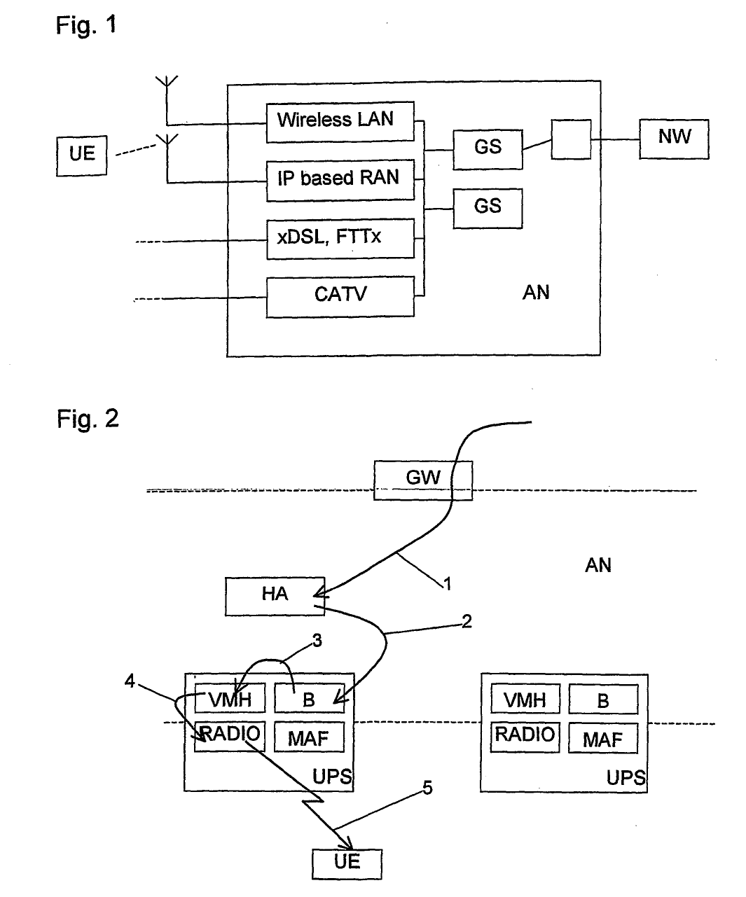

FIG. 1 A schematic of an access network that enables mobile terminals access to a network such as the Internet.

FIG. 2 Components of the access network that assist in the transmission of data packets from the network to a terminal connected to the access network, as well as the stages of the transmission of a data packet to the terminal.

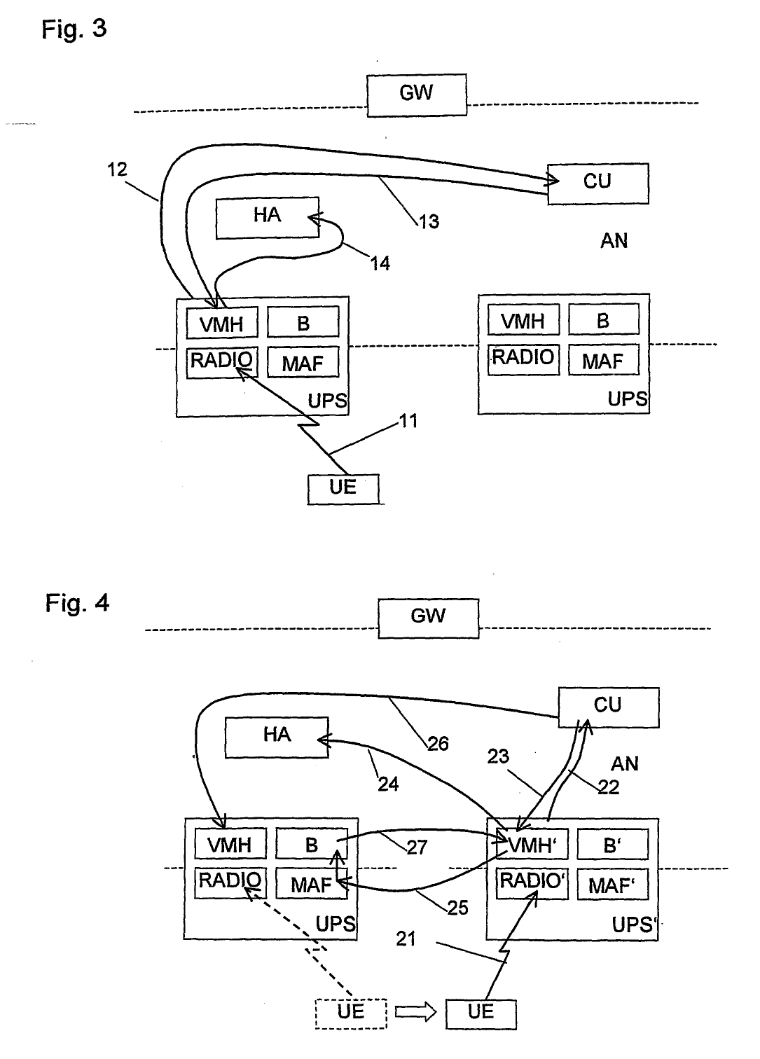

FIG. 3 The creation of a virtual processor at a node of the access network.

FIG. 4 The relocation of a virtual processor from an old to a new node of the access network.

As can be seen from FIG. 1, the access network AN has a number of gateway servers GS, that can be set up at various locations of a country and each of which has an interface to a network NW, such as the Internet. The gateway servers GS function independently of each other. Several of them are present in order that the access paths to the network NW for the individual terminals UE do not become too long.

The Internet is only an example of a network NW whose access switching can be used for the access network AN described here. A further application, for example, would be the linking of mobile terminals UE of the staff of a company to the company's own network NW based on an Internet protocol.

The network NW supports the linking of terminals UE via a radio communication system, via a wireless LAN, via line-based broadband services such as xDSL (Digital Subscriber Line), optical fiber networks or broadband cable television CATV. However, in the following only the aspect of the link using the radio communication system is considered in detail.

FIG. 2 shows some of the components of the access network AN important for data transport and explains the stages of transmission of a data packet to a terminal UE connected to the access network AN.

For this, it is first assumed that the terminal has an address permanently assigned to it and is known to a device outside the access network (not illustrated) sending a data packet to the terminal UE. One possibility of also allocating this address dynamically is shown later. This address can, as stated in the introduction, be represented as a sequence of numbers separated by periods in the form a1.b1.c1.d1 with the first numbers a1, b1 of this address designating the access network AN in which the terminal UE is located, and the succeeding numbers c1, d1 identifying a node of the access network AN or the terminal UE within the access network AN.

A data packet addressed in this way, coming from the network NW, in this case the Internet, reaches an Internet gateway GW of the access network AN. At the Internet gateway GW, a format adaptation of the transiting data packet from the format of the Internet NW to that of the access network NW, or vice versa, takes place if necessary. A number of nodes, designated User Plane Server UPS, are connected directly or indirectly to the gateway GW and are able to exchange data with the connected terminals. Starting from the gateway GW, the data packet is forwarded corresponding to the succeeding numbers c1, d1 of its address in the access network NW in the direction of a node UPS that corresponds to the address contained in the packet. This process is shown by an arrow 1 in FIG. 2. This home node, as it is called, is for example, located at the home location of a user of the terminal UE, so that when the user connects to the access network from his home location, data packets meant for him are always sent to the correct node without diversion. On the way there, the data packet reaches what is known as a home agent HA of the terminal UE, that serves to detect the data packet addressed to the terminal UE and send it out again, provided with a second address, known as the care-of address, if the terminal UE is not at its home node but is instead at a different node of the access network AN.

The forwarding (arrow 2) can take place by a simple exchange of the first address for the second address. But because this would lead to a violation of integrity, it is of course preferable that the home agent tunnels a detected data packet to the care-of address, i.e. “packaged” in one or more new data packets in such a way that the first address is retained and is forwarded as part of the payload in a new packet. This enables the recipient of data to trace the movement of a data packet and segregate any packets sent by error.

The care-of address with which the home agent HA provides the detected packet is not as one might expect that of a terminal connected to one of the nodes UPS, but is instead that of a virtual processor established at the relevant node UPS and designated here also as a Virtual Mobile Host VMH.

A node UPS can have a number of such virtual processors VMH, one for each of the terminals UE connected to the node, that remains only temporarily in the area of the node, i.e. whose permanently-allocated address is not that of the node. The virtual processor VMH emulates the terminal UE, i.e. it answers data packets from the access network meant for the terminal UE in a way expected by the network from a terminal established at the same location as the location of the virtual processor VMH, and it feeds data received from the terminal UE into the access network.

A virtual process of this kind in principle has only a share of the memory capacity of the node UPS, in the illustration as buffer B, a share of the processing capacity of the node and an address, under which it can receive data packets and temporarily store them in buffer B.

The virtual processor VMH forwards received data packets via a radio link (arrow 5) to the terminal UE assigned to it. To do this, it has a radio interface RADIO, connected to a base station of a mobile radio communication system, e.g. a UMTS or GPRS system, and uses one or more of the packet data channels operated by this base station. Because this mobile radio communication system is not itself an object of the invention, it is not shown separately in FIG. 1 and also not described in detail.

The home agent shown in FIG. 2 as part of the access network AN, assigned to the terminal UE can also be located in the Internet NW of in any subnetwork connected to it, without this essentially changing the process of transmitting data packets. If the home agent is located outside the access network, the only consequence of this is that data packets meant for the terminal UE are already re-addressed to the virtual processor VMH assigned to the terminal UE at the time point at which they pass through the gateway GW.

FIG. 3 illustrates the creation of a virtual processor VMH. On the receipt of a request from the terminal UE (arrow 11) via the radio interface RADIO, the node UPS establishes contact with an administration unit CU of the access network AN (arrow 12) and causes this to allocate a first permanent address to the terminal. This address is, e.g. created using the “stateless address autoconfiguration” known from IPv6 and consists of a network prefix that designates the access network AN and an International Mobile Subscriber Identity (IMSI) of the terminal, provided in response to the request to the node, as a suffix. Because the IMSI unambiguously identifies each terminal worldwide, an address of this kind is sufficient in all cases to clearly designate the destination terminal for which a packet is meant. This address is used by the mobility administration of the access network as long as the terminal is booked into the mobile radio communication network through which the radio data traffic between the access network AN and terminal UE takes place.

Because the same permanent address is assigned to a terminal each time when booked in, this address can also be used outside the access network as the address of this terminal.

The administration unit CU further activates (arrow 13) the node UPS, with which it has established contact, to set up a virtual processor VMH to which this permanent address is assigned as its address. The new virtual processor that has been set up logs on to the home agent HA of the terminal UE (arrow 14) and reports to it its readiness to receive data, so that this allows data packets meant for the terminal UE to pass through.

The details show that a number of versions of the setting up of a virtual processor are conceivable. If it is assumed that the permanent address of a terminal UE in the access network AN has only a network prefix and IMSI, a list must then be held at the gateway that gives a node for each permanent address to which the data packets must be forwarded in order to reach the terminal (if it is connected to the nodes) or at least to reach a home agent that re-addresses the packet if the terminal is not connected to this node. A list of this kind is not necessary if the permanent address also contains details of the home node.

With the above description according to FIG. 3, it was assumed that the terminal UE had a permanent address, known outside the access network AN, whose network prefix is that of the access network AN. It is also conceivable to use the access network AN for the terminal UE whose permanent address has the prefix of a different network. In such a case, the terminal UE gives its permanent address with the request (arrow 11) to the node UPS. The node UPS recognizes that this address is outside the access network AN and, after allocating a virtual processor VHM, sends a request to the home network of the terminal UE to assign a home agent HA to the terminal in the home network, that ensures the diversion of data packets to the address of the virtual processor VMH given by the administration unit CU.

In this way, after the virtual processor and home agent have been set up, data packets for the terminal UE are correctly diverted, regardless of which nodes of the access network AN it is connected to.

If the terminal UE moves from one cell of the mobile radio communication system to another, the result is that data packets meant for the terminal must be forwarded via a different node UPS of the access network AN. The processes associated with this procedure are explained with reference to FIG. 4.

If a handover from a cell supplied via the node UPS to one supplied by a second node UPS′ is being prepared at the level of the mobile radio communication system, the new node UPS′ makes contact with the communication unit CU (arrow 22) in the same way as described with reference to FIG. 3, to enable the assignment of a virtual processor VMH′ with an address to the terminal UE at node UPS′ (arrow 23).

The new virtual processor VMH′ sends a message (arrow 24) to the home agent HA of the terminal UE, in which it reports the last address assigned to the new virtual processor VMH′ and requests the home agent to divert packets addressed to the terminal UE to the new virtual processor VMH′ from now on.

A further message (arrow 25) sent by the new virtual processor VMH′ to a mobility administration unit MAF of the old node UPS requests it to access the buffer B and to re-address data packets found therein and still not transmitted from the old processor VMH to the terminal, particularly those data packets that were in transit to the old VMH in the access network AN before the changeover of the home agent HA to the new virtual processor VMH′ and reached buffer B bit by bit, to the new virtual processor VMH′ and retransmit them (arrow 27).

Simultaneous with a message to the mobile administration unit MAF of the old node UPS, the administration unit CU sends a command (arrow 26) to the old node UPS, that causes this to terminate the old virtual processor VHM.

In this way, it is ensured that the data flow to the terminal UE is also forwarded without interruption if the terminal changes from one cell of a mobile radio communication system to another. The control processes—creation of a virtual processor, allocation of an address to same and the diversion of the data packet to this new address—necessary to maintain the data flow, takes place completely within the access network AN without the active participation of the terminal. The forwarding of the data packets in the access network is thus completely transparent for the terminal, i.e. an adaptation of the terminal is not necessary to make use of this invention.

1. Access network for switching data packets between a network (NW) and a terminal (UE) via a radio communication system, whereby the access network (AN) comprises several nodes (UPS) that are each linked with at least one radio station of the radio communication system and are able to convert data stemming from the network (NW) to a format compatible with transmission in the radio communication system, with a first address being defined for the terminal (UE), with a first data control unit (HA) to detect data packets carrying a first address and circulating in the access network (AN) and mark the data packets with a second address,
characterized in that at least a second address is the address of a processor (VMH) established at one of the nodes (UPS) and clearly assigned to the terminal (UE), that performs the format conversion of the data from that used by the access network to a format compatible with transmission in the radio communication system, with the node having a number of processors, one for each terminal assigned to the node.

2. Access network in accordance with claim 1, characterized in that the processor (VMH) is virtual.

3. Access network in accordance with claim 1 or 2, characterized in that the processor (VMH) is assigned a second data control unit (MAF), that is capable of detecting data packets addressed to the processor and marking them with a third address.

4. Access network in accordance with one of the preceding claims, characterized in that it is a network based on Internet Protocol, particularly a Mobile IP network or an IPv6 network or a CIP network (cellular IP).

5. Method for switching data packets between a network (NW) and a terminal (UE) via an access network (AN) that has a number of nodes (UPS), each of which is connected to at least one radio station of a radio communication system, with a first address being defined for the terminal (UE), whereby packets marked with the first address are detected by a data control unit (HA) of the access network (AN), provided with a second address and forwarded to a node (UPS), where a conversion of the packets from a format used by the access network to a format compatible with transmission in the radio communication system takes place, and
with the converted packets being sent from a first radio station connected to the nodes to the terminal (UE),
characterized in that the second address corresponds to a first processor (VMH) established at one of the nodes (UPS) and clearly assigned to the terminal (UE), that performs the data conversion, with the nodes having a number of processors, one for each terminal assigned to the node.

6. Method in accordance with claim 5, characterized in that when the terminal has moved from a geographical region assigned to the first radio station to that of a second radio station, the packets detected in the access network (AN) are marked with a third address and are forwarded to nodes (UPS′) connected to the second ratio station, with the third address corresponding to a processor (VMH′) established at the second node (UPS′).

7. Method in accordance with claim 6, characterized in that the processor (VMH′) established at the second node (UPS′) is a virtual processor, that is created on the change of the terminal (UE) to the geographical region of the second radio station at the second node (UPS′).

8. Method in accordance with claim 6 or 7, characterized in that on the change of the terminal (UE) to the region of the second radio station, the third address is given and communicated to the data control unit (HA), whereupon the data control unit (HA) marks the packet detected with the first address with the third address.

9. Method in accordance with claim 6, 7 or 8, characterized in that on the change of the terminal (UE) to the region of the second radio station, the third address is allocated and communicated to the node (UPS) of the first processor (VMH), whereupon the first processor (VMH) is deactivated and packets in this node (UPS) addressed to it are marked with the third address.

10. Method in accordance with one of claims 5 to 9, characterized in that the first-address is created by combining a designator specific to the terminal with a prefix specific to the access network.

11. Method in accordance with claim 10, characterized in that the designator is the IMSI of the terminal.
